(19) United States
(12) Patent Application Publication
(10) Pub. No.: US 2001/0044778 A1
(43) Pub. Date: Nov. 22, 2001

(54) Electronic commercial transaction system

(76) Inventors: Osamu Hoshino, Tokyo (JP); Hiroaki Okazaki, Tokyo (JP); Terukazu Asami, Tokyo (JP); Haruhiko Usui, Tokyo (JP); Toshikazu Ichikawa, Tokyo (JP)

Correspondence Address: TRASK BRITT, P.O. BOX 2550, SALT LAKE CITY, UT, 84110, US

(21) Appl. No.: 09/776,995

(22) Filed: Jun. 25, 2001

(30) Foreign Application Priority Data
Feb. 4, 2000 (JP) 27813/2000

(51) Int. Cl. G06F 17/60; H04K 1/00; H04L 9/00

(52) U.S. Cl. 705/44; 705/72; 705/75

(57) ABSTRACT

The present invention provides a commercial transaction system which enables goods to be sold and bought with high accuracy without anxiety by using a computer network such as the Internet, and which can also give credit information in commercial transaction. The electronic commercial transaction system according to the invention includes plural electronic terminals connected to one another by a computer network, and an authentication station connected to the computer network. An electronic certificate and a company code are assigned to each of the electronic terminals on the basis of examination performed by the authentication station, and when a commercial transaction is to be performed between one and another of the electronic terminals via the computer network, both selling and buying sides of the commercial transaction present the respective electronic certificates before performing the commercial transaction.

### BACKGROUND OF THE INVENTION

1. Field of the Invention

The present invention relates to an electronic commercial transaction system which enables commercial transactions and sending of documents by the use of a computer network(such as the Internet) and, more particularly, to an electronic commercial transaction system which is realized with high accuracy and reliability and enables smooth business or acquisition of company information.

2. Description of the Related Art

For example, online shopping has been practiced where a seller provides a buyer with information about an item for sale and the buyer reads the information about the item and can buy the item by the use of a computer network such as the Internet. In addition, services have been practiced which provide various information on a charged or free basis by using a computer network such as the Internet.

In such online shopping, the seller and the buyer perform commercial transactions by inputting data on the screen of a computer without seeing the face of each other, so that the buyer worries about whether the seller really exists and can sell the item to the buyer, whereas the seller worries about whether the buyer really exists and can pay for the item. However, the related art computer network is constructed so that the seller and the buyer are forced to perform commercial transactions while feeling such uneasiness about each other, and troubles often occur in commercial transaction. On the network where network participants cannot see each other's face, there is a risk that a dishonest participant performs the illegal act of passing himself off as a company which does not really exist or a different company.

In addition, the market scale of electronic commercial transaction is expected to become larger and larger in the future. For this reason, there has been a strong demand for the development of a system which enables a seller and a buyer to reliably perform commercial transactions without anxiety.

### SUMMARY OF THE INVENTION

The present invention has been made in view of the above-described circumstance, and provides an electronic commercial transaction system which enables goods to be sold or bought with high accuracy without anxiety by the use of a computer network such as the Internet, and which can issue credit information in commercial transaction and enable documents such as files to be reliably sent and stored.

The present invention relates to an electronic commercial transaction system, and is achieved by a construction which includes plural electronic terminals connected to one another by a computer network, and an authentication station connected to the computer network, an electronic certificate and a company code being assigned to each of the electronic terminals on the basis of examination performed by the authentication station, and when a commercial transaction is to be performed between one and another of the electronic terminals via the computer network, both selling and buying sides of the commercial transaction presenting the respective electronic certificates before performing the commercial transaction.

In addition, the present invention is achieved by a construction which includes plural electronic terminals connected to one another by a computer network, and a member database, an automatic authorization database, an issuing database, a company information database and an electronic document sending archive database all of which are connected to the computer network, an electronic certificate as well as a company code and a PIN being assigned to each of the electronic terminals on the basis of examination performed by the authentication station, a commercial transaction being performed between one and another of the electronic terminals via the respective electronic certificates on the computer network, company information being provided by inputting the corresponding company code.

### BRIEF DESCRIPTION OF THE DRAWINGS

The present invention will become more readily appreciated and understood from the following detailed description of preferred embodiments of the invention when taken in conjunction with the accompanying drawings, in which:

FIG. 1 is a block diagram diagrammatically showing the entire construction of an electronic commercial transaction system according to the present invention;

FIG. 2 is a view showing an example of the construction of an electronic terminal for use in the present invention;

FIG. 3 shows the relationship between electronic certificates and company codes for use in the present invention;

FIG. 4 is a time chart showing an example of the operation of issuing an electronic certificate for use in the present invention;

FIG. 5 is a system flowchart showing the manner of issuing the electronic certificate for use in the present invention;

FIG. 6 is a time chart showing an example of the operation of issuing the electronic certificate for use in the invention;

FIG. 7 is a system flowchart showing an example of the operation of issuing the electronic certificate for use in the present invention;

FIG. 8 is a screen view showing one example of the electronic certificate for use in the present invention;

FIG. 9 is a time chart showing an example of the operation of commercial transaction in the present invention;

FIG. 10 is a time chart showing an example of the operation of electronic document archive service according to the present invention;

FIG. 11 is a view showing an example of personal utilization of the electronic document archive service;

FIG. 12 is a view showing an example of group utilization of the electronic document archive service;

FIG. 13 is a time chart showing an example of the operation of discarding an electronic certificate for use in the present invention; and

FIG. 14 is a system flowchart showing the manner of discarding the electronic certificate for use in the present invention.

### DESCRIPTION OF THE PREFERRED EMBODIMENTS

In the electronic commercial transaction system according to the present invention, in order to enable transaction subjects such as a seller of goods and a buyer to perform commercial transactions without anxiety, both transaction subjects can perform confirmation of the existence of each other and confirmation of the identity of each other by presenting an electronic certificate issued by an authentication station which is a neutral third-party organ. In addition, in electronic commercial transaction, as to not only the confirmation of the existence of a transaction participant and the confirmation of the identity thereof but also a credit decision to which scrupulous attention needs to be paid, company information is disclosed to only a participant that presents an electronic certificate. Moreover, in communication means using a computer network, there are problems such as the difficulty in confirming the arrival of an e-mail, dishonest alteration of an e-mail or refusal to receive an e-mail. However, in the present invention, there is provided a server which is managed by an authentication station so that a transaction participant can be informed of the sending of a document and a sending party can be informed of the reception of the document and both parties can mutually confirm the sent document, whereby electronic sending of an important document such as an order or a bill can be performed without anxiety.

Embodiments of the present invention will be described below with reference to the accompanying drawings.

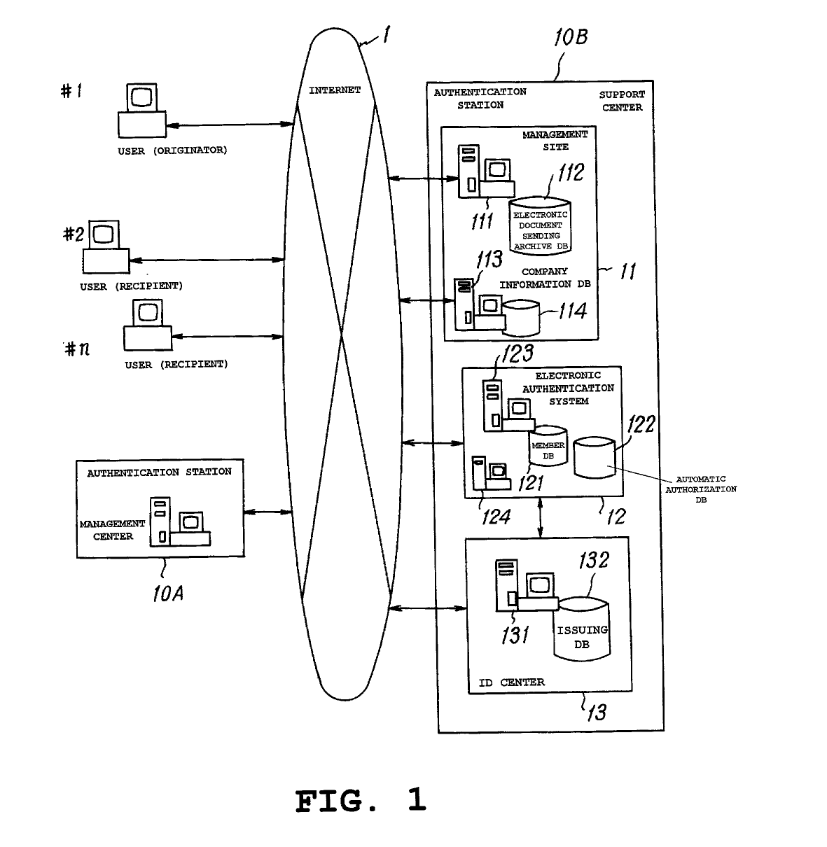

FIG. 1 diagrammatically shows the entire construction of the present invention. Electronic terminals(personal computers) # 1 to #n are connected to the Internet 1 which is used as a computer network, and an authentication station 10 which is a neutral third-party organ is connected to the Internet 1 via various servers. In FIG. 1, one user(originator) and two users(recipients) are shown as the electronic terminals (personal computers) #1 to #n. The authentication station 10 is divided into a management center 10A which performs authentication and management activities, and a support center 10B which performs support services for electronic commercial transaction. The support center 10B is equipped with a management site 11, an electronic authentication system 12 and an ID center 13. The management site 11 has an electronic document sending archive server 111 and an electronic document sending archive database 112 as well as a company information server 113 and a company information database 114. The electronic authentication system 12 is equipped with an automatic authorization server 123 having a member database 121 and an automatic authorization database 122, and an accepting server 124. The ID center 13 is equipped with an issuing server 131 and an issuing database 132.

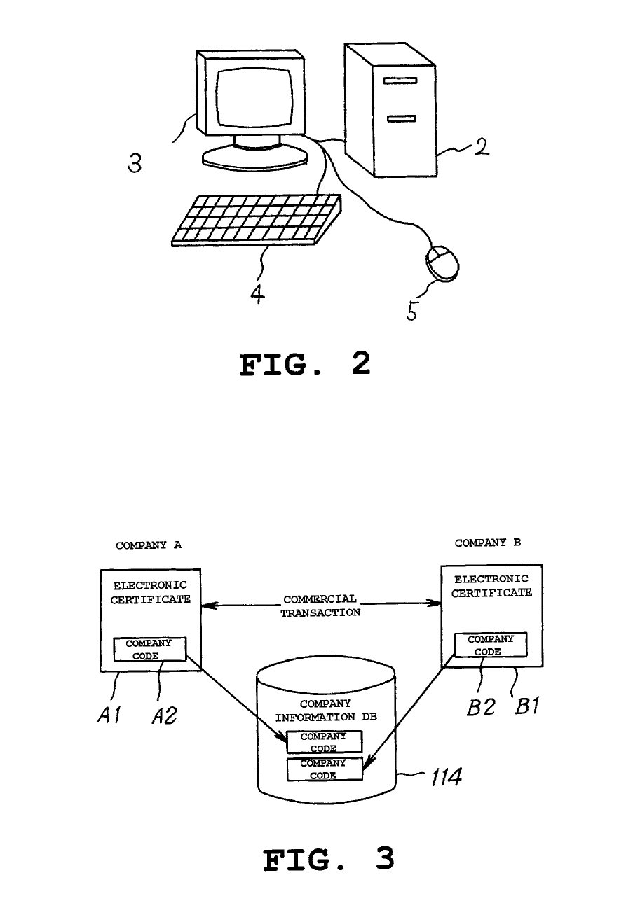

The users' electronic terminals(personal computers) #1 to #n are generally constructed as shown in FIG. 2. Specifically, each of the electronic terminals #1 to #n is constructed of a CPU unit 2 having the function of copying and driving CDs or FDs, a display unit 3 such as a CRT or a LCD, and a keyboard 4 and a mouse 5 for inputting data, commands and the like.

Owing to such an arrangement and construction, the electronic terminals #1 to #n can perform communications with one another and perform commercial transactions or the like via the Internet 1. In the present invention, the authentication station 10 is connected to the Internet 1, and these communications and commercial transactions are performed via the authentication station 10 so that safe and reliable commercial transactions can be realized. To this end, in the present invention, an electronic certificate is issued as certification of the membership of the authentication station 10, and communications and commercial transactions are performed through the presentation and confirmation of the electronic certificate.

First, the electronic certificate used in the invention will be described below. FIG. 3 shows the manner of utilization of the electronic certificate in schematic form, for ease of understanding. A company “A” has an electronic certificate A1 issued from the authentication station 10, and a company “B” has an electronic certificate B1 issued from the authentication station 10. Both of the companies “A” and “B” are respectively assigned company codes A2 and B2 by the authentication station 10, and their respective electronic certificates are assigned the company codes. Company information about the companies “A” and “B” are stored in the database 114 of the company information server 113 in the state of being organically linked in the form of corresponding to the respective company codes A2 and B2. In the case where the company “A” and the company “B” perform a commercial transaction, the company “A” presents the electronic certificate A1, while the company “B” presents the electronic certificate B1, whereby the companies “A” and “B” can mutually confirm that they are companies authenticated by the authentication station 10. In addition, if a company inputs a company code assigned in advance, the company can obtain company information about a company corresponding to the company code. Accordingly, for example, if the company “A” inputs the company code of the company “B”, the company “A” can obtain company information such as the business result and the credit rating of the company “B”.

Such an electronic certificate does not at all contain information and elements associated with credit records, and is issued exclusively on the basis of the results of existence confirmation and identity confirmation. However, there is naturally a difference in reliability between an authentication station which issues an electronic certificate on the basis of the presentation of a commercial registration or a certificate of the seal impression of a representative and an authentication station which issues an electronic certificate by performing confirmation of the address and the existence of a transaction subject on a face-to-face basis. A target to which to issue the electronic certificate is a company, but is not limited to only a representative and the electronic certificate may also be issued to a department or a section of the company. Finally, the electronic certificate can be issued to each person belonging to the company.

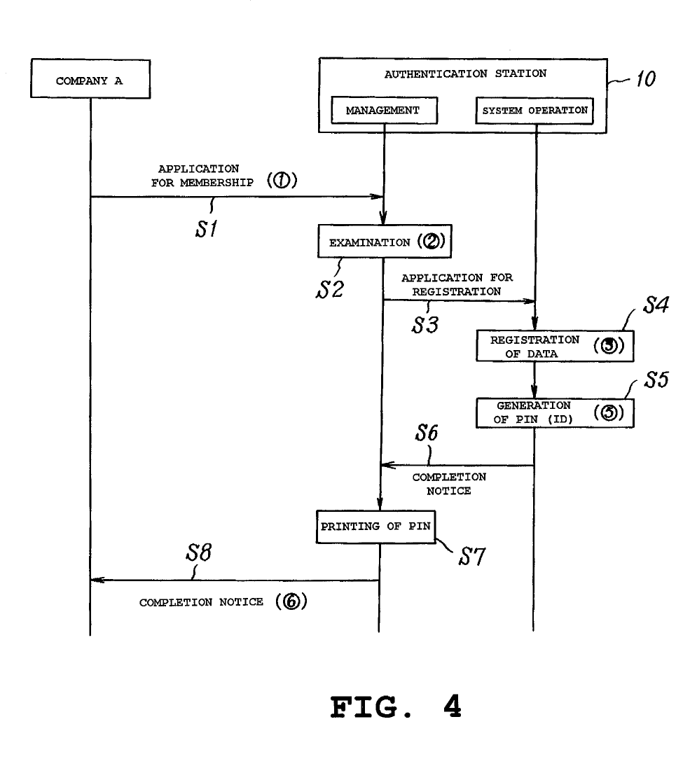

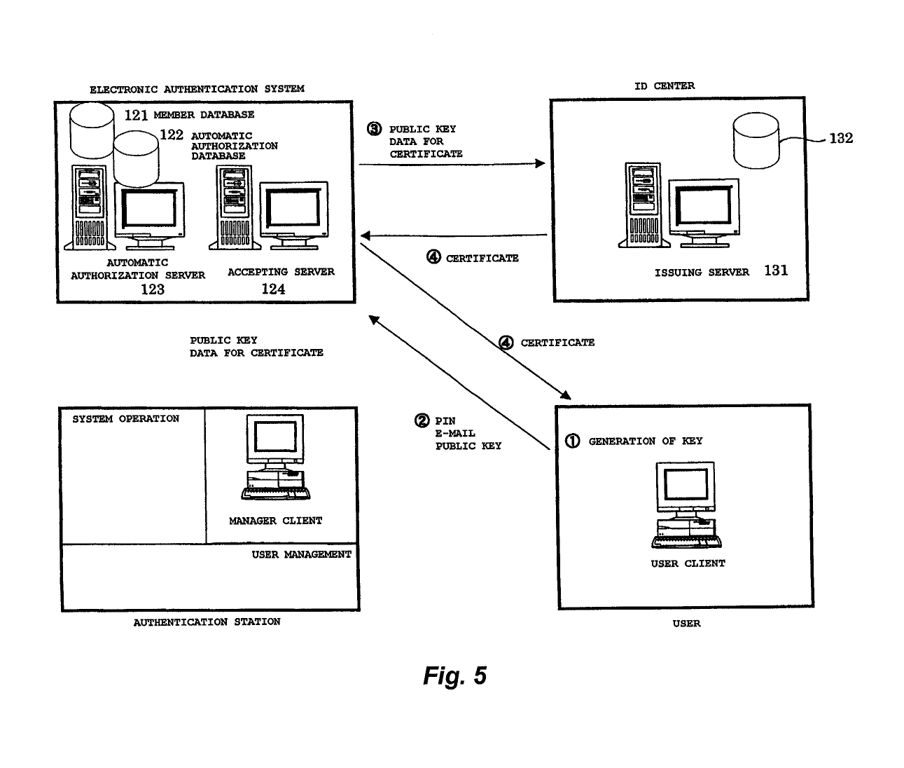

The issuance of an electronic certificate to be performed by the authentication station 10 will be described below. For example, if the company “A” is to register as a member, first of all, the processing shown in FIGS. 4 and 5 is performed. Specifically, a person belonging to the company “A” writes the required information such as his name, his name written in roman letters and his e-mail address onto a predetermined application form and puts his seal on the document, and applies for membership to a management section of the authentication station 10(Step S1, Part \mathring{1} of FIG. 5). When receiving the application, the authentication station 10 performs examination of the company “A” which is an applicant(Step S2, Part \mathring{2} of FIG. 5). The examination is performed in such a way that the identity of the applicant person is confirmed on a face-to-face basis and the existence of the company “A” to which the person belongs is confirmed through on-site inspection. If the examination is passed, the applicant applies for registration to a system operating section(Step S3), and the system operating section registers company information about the applicant company “A” and applicant information onto the member database 121 provided in the electronic authentication system 12(Step S4, Part \mathring{3} of FIG. 5). After the registered data has been confirmed(Part \mathring{4} of FIG. 5), a PIN(Personal Identification Number) is generated when the data is to be transferred from the member database 121 to the automatic authorization server 123(Step S5, Part \mathring{5} of FIG. 5), and the transferred data is stored in the automatic authorization server 123. When the registration is completed, a completion notice is sent from the system operating section to the management section(Step S6), and the management section prints the PIN(Step S7) and informs the company “A” that the registration has been completed, and sends the company “A” the generated PIN to that effect(Step S8, Part \mathring{6} of FIG. 5).

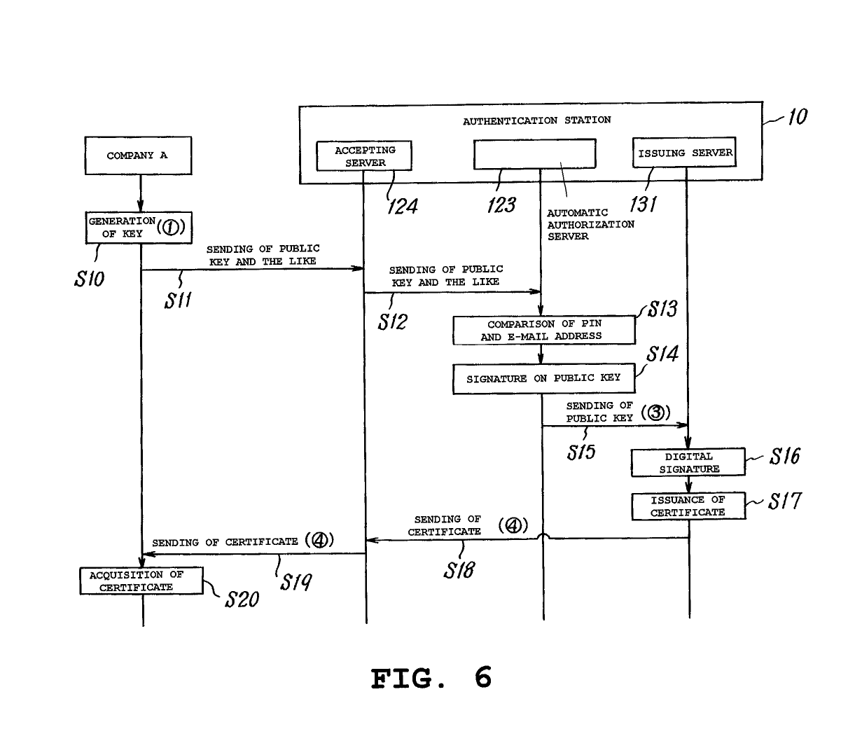

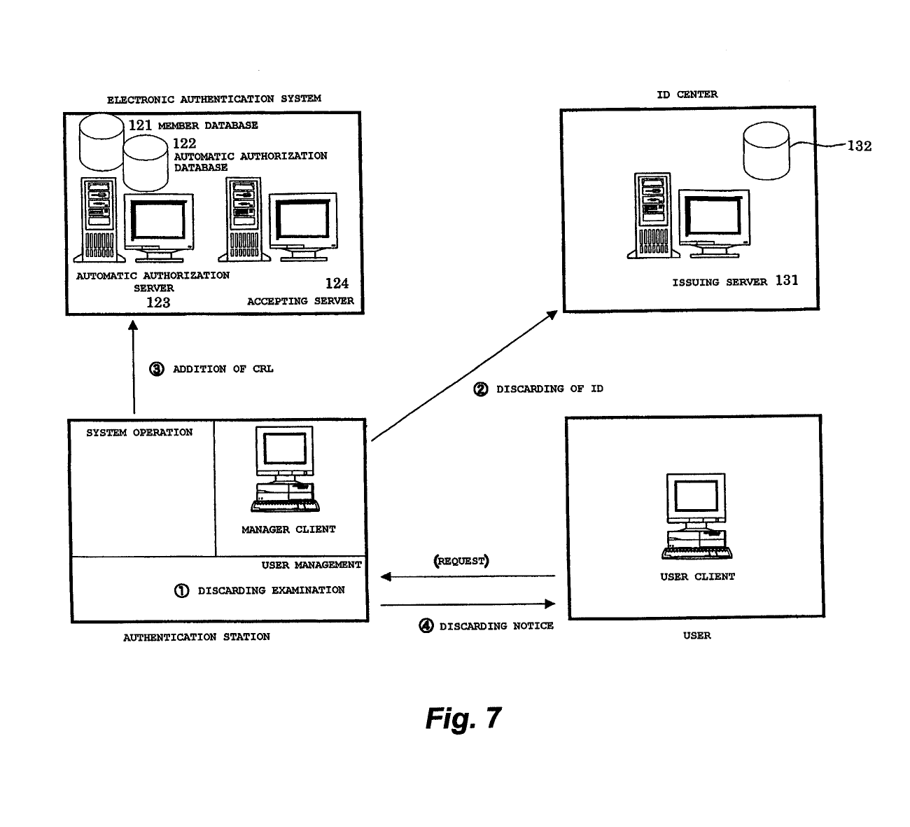

After that, as shown in FIGS. 6 and 7, the company “A” generates one pair of keys(secret keys or public keys) by using a browser at an electronic terminal(Step S10, Part \mathring{1} of FIG. 7), and transfers the public keys, the PIN and the e-mail address to the automatic authorization server 123 through the accepting server 124 of the authentication station 10 via the Internet 1(Steps S11 and S12, Part \mathring{2}of FIG. 7). When the public keys, the PIN and the e-mail address are transferred to the automatic authorization server 123, the automatic authorization server 123 compares the transferred public keys, PIN and e-mail address with previously-registered data(PIN and e-main address)(Step S13) and, after confirmation, puts its digital signature on the transferred public keys(Step S14). After that, the public keys(as well as certificate-written data such as the name and the company code) are transferred to the issuing server 131 of the ID center 13(Step S15, Part \mathring{3} of FIG. 7). The issuing server 131 puts its digital signature on the transferred public keys(Step S16), and issues an electronic certificate to which a serial number and the term of validity are added(Step S17). The issued electronic certificate is transferred to(Steps S18 and S19), and stored in(Step S20), the browser of the company “A” via the accepting server 124 of the electronic authentication system 12. When the electronic certificate is passing through the accepting server 124, data such as the term of validity and the serial number are transferred to and stored in the member database 121.

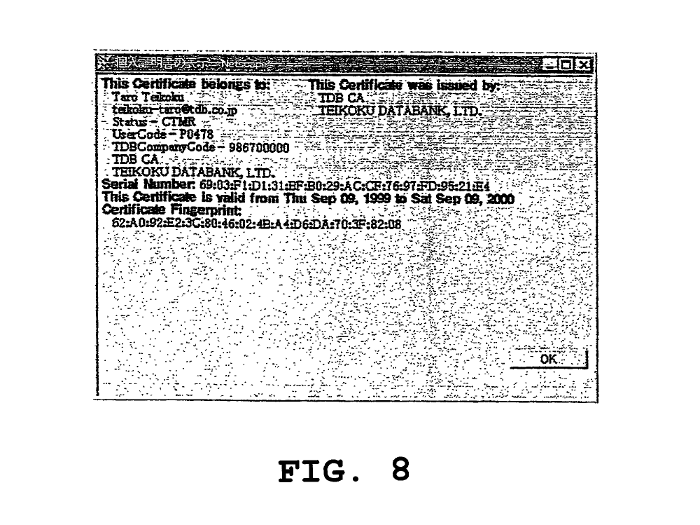

The electronic certificate issued in this manner has contents such as those shown in FIG. 8, i.e., recordings such as the name of the issuance station, the address and name of the owner, the e-mail address of the owner, the issuance station number, the company code, the serial number and the term of validity.

Incidentally, if plural electronic certificates are to be issued to one member, a person in charge of registration is selected from among users who have previously acquired electronic certificates, and the person collects information about all the users, and requests the authentication station 10 to issue electronic certificates, in an on-line manner or through an application form. Normally, a user who has acquired the first electronic certificate serves this role. In the case of an on-line application, the user uses the acquired electronic certificate to access a registration screen, and performs registration, while in the case of registration using an application form, the user makes application to a person in charge in the authentication station 10. In either case, the authentication station 10 makes contact with the applicant person by telephone or the like, and performs confirmation of the identity of the applicant person and confirmation of the existence thereof.

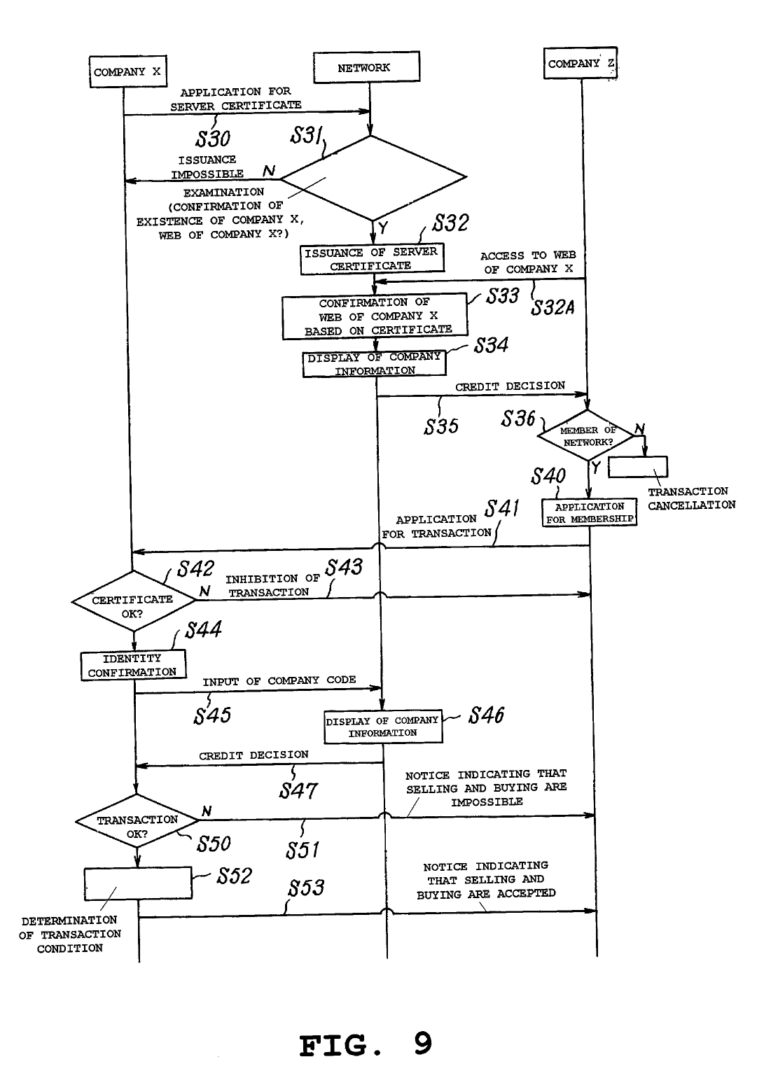

The operation of, for example, a company X and a company Z to perform commercial transactions such as selling and buying of goods by using the Internet 1 will be described below with reference to FIG. 9. In the following, reference will be made to an example in which the company X sells goods and the company Z buys goods.

First of all, if the company X is to perform a commercial transaction on the network, the company X applies for a server certificate to the authentication station 10 in order to certify the identity of the website of the company X(Step S30). The authentication station 10 performs examination similarly to the issuance of an electronic certificate(Step S31), and issues a server certificate to the website of the company X which has passed the examination(Step S32). The server certificate stores a company code which identifies the company X, and company data can be referred to by using the company code as a key. The company Z which desires to perform commercial transactions at the website of the company X accesses the website of the company X(Step S32A), and confirms from the server certificate whether the website is really the website of the company X(Step S33). The company Z acquires company information by accessing the company information database 114 from the company code stored in the server certificate(Step S34), and makes a credit decision(Step S35). The company Z determines whether to become a member of the network, in accordance with the credit decision(Step S36).

If, in the Step S36, the company Z determines to start a commercial transaction, the company Z performs application for an electronic certificate which is specified as a transaction condition by the company X(Step S40). The contents of the processing is the same as those described above with reference to FIGS. 4 and 5, and the authentication station 10 which has received the application performs examination of the company Z, and issues the electronic certificate if the examination is passed. Although the company Z uses an e-mail as communication means on the network, the company Z puts a digital signature on an e-mail to be used for a commercial transaction with the company X, by means of the electronic certificate. Putting the digital signature enables identity confirmation(Steps S42 and S44), and the company X accesses the company information database 114 from the company code stored in the electronic certificate and acquires company information about the company Z(Step S46), and can make a credit decision(Step S47).

On the basis of the credit decision, the company X determines whether to accept the transaction(Step S50), and if the company X does not desire to perform the transaction, the company X sends the company Z a notice to the effect that dealing is impossible(Step S51). If the company X is to perform the transaction, the company X defines transaction conditions(Step S52) and sends the company Z a notice to the effect that dealing is accepted(Step S53).

Electronic certificates can also be used for the control of access to websites. For examples, if the company Z accesses the website of the company X, the server of the company X requests the company Z to present an electronic certificate, and determines whether the presented electronic certificate is proper. If it is not proper, the company X can refuse access, whereas if it is proper, the company X can permit access. The company X can perform confirmation of the identity of the company Z and acquisition of company information about the company Z, by the electronic certificate presented in a similar manner to that performed during the use of an e-mail.

In the present invention, the presentation of an electronic certificate is made an obligation because the use of IDs and passwords becomes a problem in terms of security in an open space such as the Internet. Users(in the example shown in FIG. 9, the company Z) refer to company information via the Internet by means of a browser such as “Netscape Navigator” or “Internet Explorer”. Accordingly, providers are basically responsible for connection support.

For example, if the member X is to send data to the member Z by using a safe network provided by the authentication station (electronic commercial transaction support section), the member X presents an electronic certificate to enter the network. The authentication station determines whether the electronic certificate is proper, and if the electronic certificate is not proper, participation of the member X into the network is refused. If the electronic certificate is proper, participation of the member X into the network is permitted and the member X becomes able to send data. The member X sends data to be sent to the member Z and a message to the member Z, to a server on the network, and the server stores the data and adds information to the message from the member X, and sends the resultant message to the member Z. The member Z that has received the message requests the network to send data, and presents an electronic certificate similarly to the member X before entering the network. The member Z that has entered the network instructs the server to send data, and receives the data. The server records the reception of the data by the member Z, and the member X can confirm the arrival of the data by accessing the server on the network.

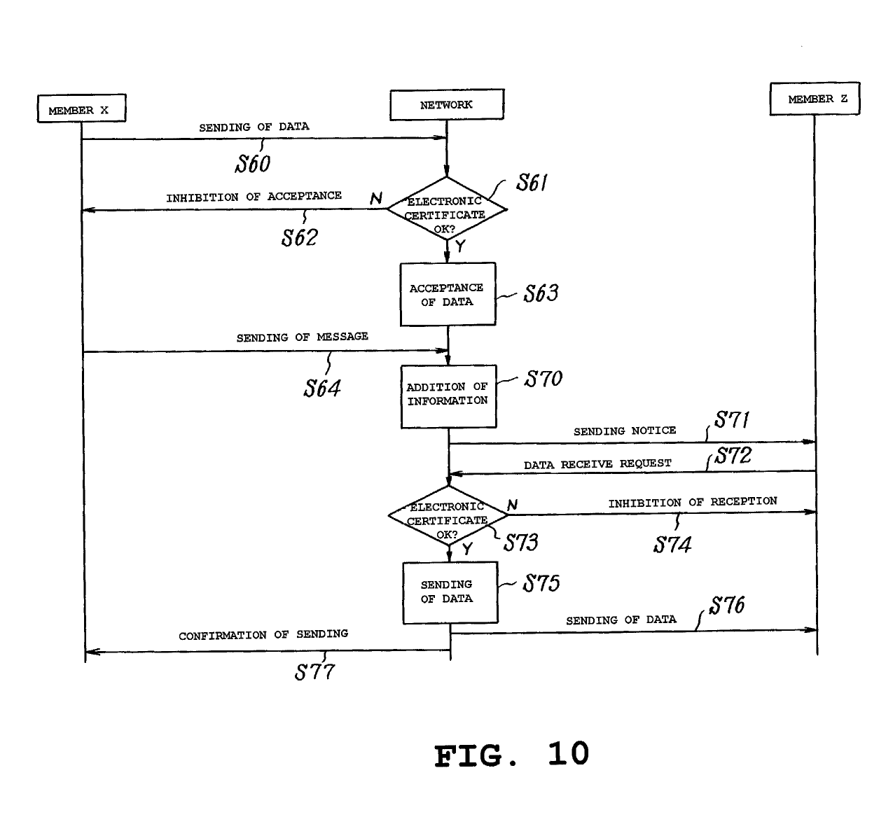

FIG. 10 shows an operational example of an electronic document sending archive service which enables data, documents or the like to be exchanged between the member X and the member Z. If the member X is to send data to the member Z(Step S60), it is determined whether the electronic certificate of the member X to be sent together with the data is proper(Step S61), and if the electronic certificate is not proper, data acceptance is inhibited(Step S62). If the electronic certificate is proper, the data is accepted by an accepting server on the network(Step S63). After that, a message from the member X is sent(Step S64), and the required information such as an achieve location is added to the message(Step S70). After the reception of the data, the accepting server sends the member Z, i.e., a side to which to send the data, a notice to the effect that the data sent to the member Z exists(Step S71). In response to this notice, the member Z requests the network to send the data(Step S72), and it is determined whether the electronic certificate presented by the member Z is proper (Step S73). If the electronic certificate is not proper, data reception is inhibited(Step S74), whereas if the electronic certificate is proper, the electronic document sending archive server 111 is given an instruction to send the data(Step S75) and the data is sent to the member Z(Step S76). In addition, the member X can confirm whether the data has arrived at the electronic document sending archive server 111(Step S77).

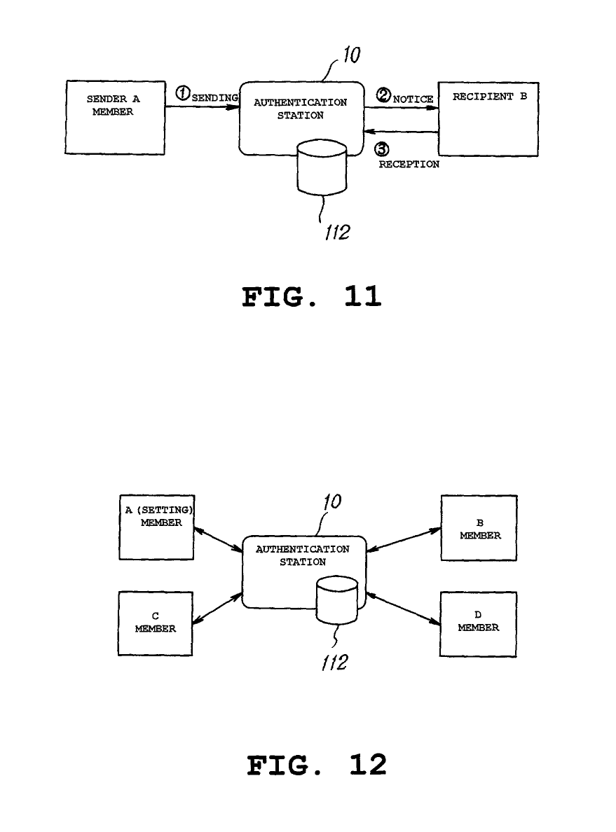

FIG. 11 shows the manner of the personal service described above with reference to FIG. 10. If a sender “A”(member) is to send a file or a message to a recipient “B”(member or non-member), the sender “A” sends it to the electronic document sending archive server 111 of the authentication station 10 without sending it directly to the recipient “B”. The authentication station 10 that has received it sends the recipient “B” a notice to the effect that there is matter to be communicated from the sender “A” to the recipient “B”. In response to the notice, the recipient “B” accesses the electronic document sending archive server 111 and receives the matter sent from the sender “A”. The authentication station 10 can confirm that the matter sent from the sender “A” has arrived at the recipient “B”, when the recipient “B” performs the operation of taking the data out of the electronic document sending archive server 111. The authentication station 10 also performs archiving of the sent data, and the archiving period of the data can be selectively specified by the sender “A” at the time of sending the data. The archived data can be taken out at any time, but cannot be modified and also cannot be deleted until the term expires.

FIG. 12 is a view showing the manner of electronic document archive service performed by a group. Participants in this case are limited to members having electronic certificates. The setting of the group can be freely performed in an on-line manner, and the management of the group can be performed by an electronic certificate holder(in this example, “A”) that set the group. The manager can perform addition and deletion of a group participant, and deletion of data. When each of the members accesses the electronic document sending archive server 111 of the authentication station 10 by using their electronic certificates, each of the members can refer to the history of communications performed among the members or can download and view archived data.

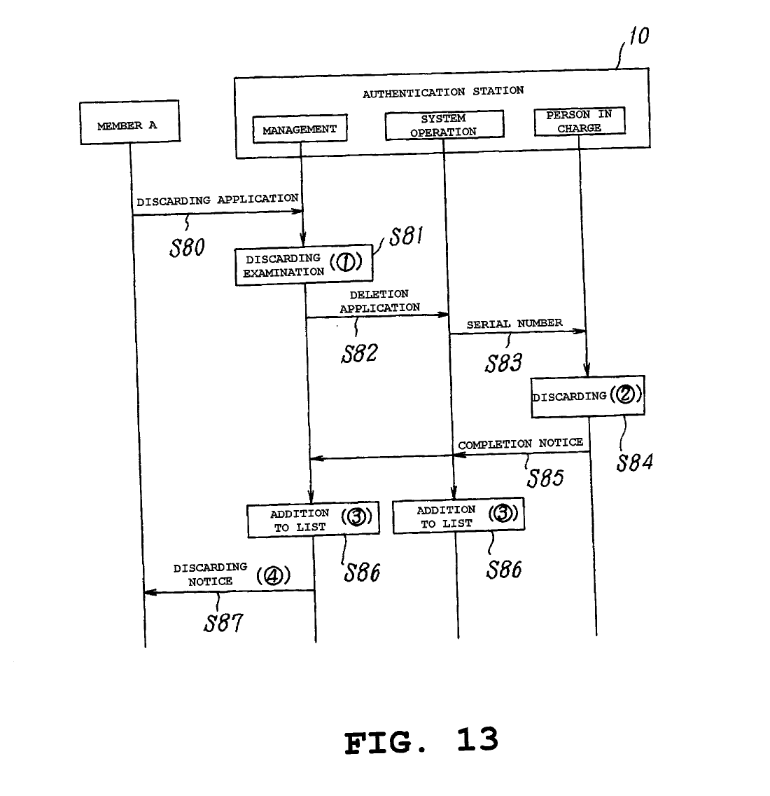

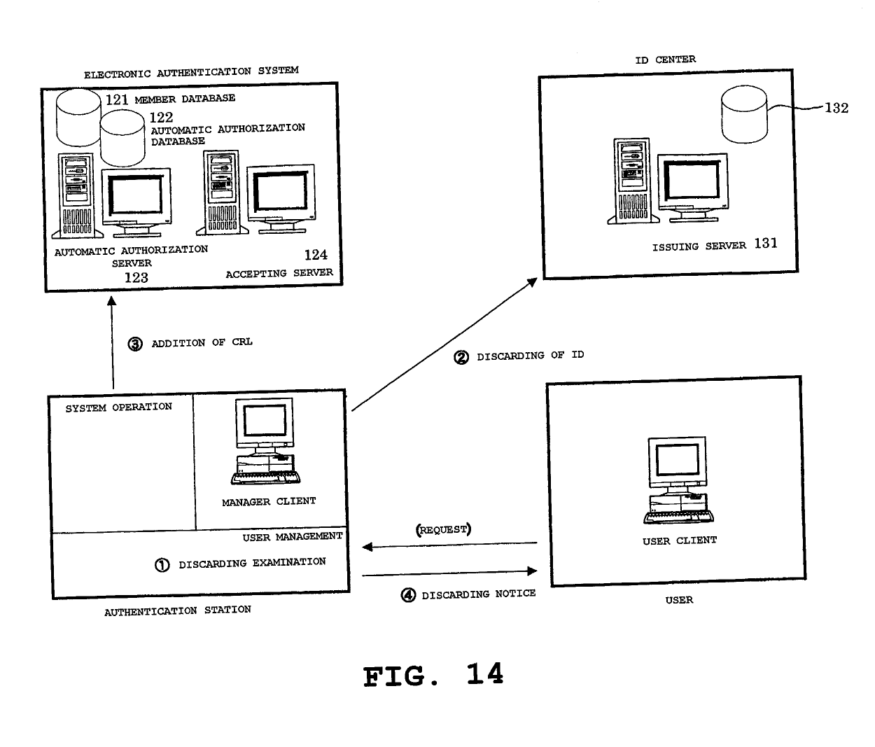

FIGS. 13 and 14 show the operation of scrapping an issued electronic certificate. The management section of the authentication station 10 performs discarding examination on the basis of a discarding application made by, for example, the sender “A”(Steps S80, S81, Part \mathring{1} of FIG. 14). Not only is this discarding examination performed in response to such discarding application, but may also be performed on the basis of variation information independently acquired by the authentication station 10. If it is determined from the result of the examination that discarding is to be performed, the management section of the authentication station 10 applies for deletion of the electronic certificate of the sender “A” to the system operating section(Step S82), and the system operating section informs a section in charge of the serial number of the electronic certificate(Step S83). The section in charge performs discarding in accordance with this application(Step S84, Part \mathring{2} of FIG. 14), and sends a completion notice to each of the system operating section and the management section(Step S85). The contents of the discarding list provided in each of the system operating section and the management section are modified or new contents are added to the discarding list(Step S86, Part \mathring{3} of FIG. 14). After that, the management section sends the sender “A” a notice which the discarding of the electronic certificate of the applicant concerned has been completed(Step S87, Part \mathring{4} of FIG. 14).

As described above, according to the electronic commercial transaction system of the present invention, commercial transactions on a computer network can be safely and reliably performed by the use of company information using electronic certificates and company codes as media. Specifically, there are some companies that have introduced open procurement of materials by using the Internet, and the invention can support such companies when they need to confirm whether a company that has participated in a tender really exists and can be given an order. Accordingly, when exchange is performed of documents such tender or order documents, receipts, bills and contracts or document archiving is performed, it is possible to prevent troubles such as dishonest pretense, refusal to receive a document and dishonest alteration of a document, thereby realizing safe and reliable electronic commercial transactions.

What is claimed is:

1. An electronic commercial transaction system comprising:
plural electronic terminals connected to one another by a computer network; and
an authentication station connected to the computer network,
an electronic certificate and a company code being assigned to each of the electronic terminals on the basis of examination performed by the authentication station,
when a commercial transaction is to be performed between one and another of the electronic terminals via the computer network, both selling and buying sides of the commercial transaction presenting the respective electronic certificates before performing the commercial transaction.

2. An electronic commercial transaction system according to claim 1, wherein the authentication station is connected to the computer network via a server and has company information corresponding to the company codes, the authentication station being constructed to allow company information to be used by any of the electronic terminals that inputs the corresponding company code being inputted, only when the electronic terminal presents the electronic certificate.

3. An electronic commercial transaction system according to claim 1, wherein the examination includes on-site existence confirmation.

4. An electronic commercial transaction system according to claim 2, wherein the company information has contents that enable a user to make a credit decision.

5. An electronic commercial transaction system according to claim 2, wherein confirmation of information exchange is performed by data being sent between each of the electronic terminals via the server.

6. An electronic commercial transaction system comprising:
plural electronic terminals connected to one another by a computer network; and
a member database, an automatic authorization database, an issuing database, a company information database and an electronic document sending archive database all of which are connected to the computer network,
an electronic certificate as well as a company code and a PIN being assigned to each of the electronic terminals on the basis of examination performed by the authentication station,
a commercial transaction being performed between one and another of the electronic terminals via the respective electronic certificates on the computer network, company information being provided by inputting the corresponding company code.

7. An electronic commercial transaction system according to claim 5, wherein the PIN is registered in the automatic authorization database, an inputted PIN being authorized with the registered PIN to issue the electronic certificate from the issuing database.
